(19) United States
(12) Patent Application Publication
(10) Pub. No.: US 2013/0005688 A1
(43) Pub. Date: Jan. 3, 2013

(54) INSECTICIDAL COMPOSITION

(76) Inventors: Marie Elizabeth Saunders, Schaumburg, IL (US); Michael Dean Willis, Elgin, IL (US); Darryl Ramoutar, Geneva, IL (US); Joanna Maria Szymczyk, Chicago, IL (US); Frances Nita Krenick, Schaumburg, IL (US)

(21) Appl. No.: 13/175,405

(22) Filed: Jul. 1, 2011

(51) Int. Cl. A01N 65/12; A01P 7/04; A01N 53/10

(52) U.S. Cl. 514/74; 514/531

(57) ABSTRACT

Disclosed are insecticidal compositions and associated methods that comprise pyrethrum, pyrethrins, one or more pyrethrin, or pyrethroid and mineral oil.

### FIELD

The disclosure relates to compositions and methods useful for insect control.

### BACKGROUND

Pyrethrin esters (Pyrethrins I and Pyrethrins II) are a group of naturally occurring organic compounds contained in some perennial plants, such as chrysanthemums (e.g., Chrysanthemum cinerariaefolium) and are active ingredients in the widely-used pyrethrum extract. Pyrethrins I and pyrethrins II are compositions of structurally related pyrethrin esters that all contain a cyclopropane core. Combinations of pyrethrins I and pyrethrins II are sometimes referred to as “pyrethrins”; individual pyrethrin esters are referred to as “a pyrethrin”; and compositions containing pyrethrins shall be referred to here using the term “pyrethin.” Pyrethrins have been used as an insecticide for many years. Pyrethrins act as neurotoxins against insects and can provide immediate knockdown of flying insects even when present in amounts that are not lethal to insects. These compounds are biodegradable and are inactivated by oxidation or exposure to light. Because pyrethrins have a very low toxicity in mammals and are biodegradable (leaving little to no residue in the environment) they represent an attractive alternative to other classes of insecticidal compounds, such as organophosphates and organochlorides, which are associated with greater regulatory scrutiny and have a more significant impact on the environment. Accordingly, pyrethrins as well as the class of structurally related synthetic compounds known as the pyrethroids, are used in a wide variety of applications, including formulations for indoor and outdoor use, to such an extent that there are approximately 1,350 end-use products containing pyrethrins registered with the United States Environmental Protection Agency (EPA) for use in agricultural, commercial, residential, and public health applications [Pyrethrins Reregistration Eligibility Decision, EPA 2006].

While pyrethrins have potent insecticidal and knockdown activity, they are susceptible to detoxification mechanisms induced by an insect's metabolic processes. Also, fast and efficient insect knockdown does not necessarily correlate to insect death, as insects can recover after the initial knockdown. The industry has addressed these characteristics by adding synergists such as piperonyl butoxide (PBO) to pyrethrin insecticidal compositions to enhance potency by slowing detoxification. Currently there are approximately 1,500 end-use products registered in the United States containing PBO as a synergist with other active ingredients for use on agricultural and residential sites [PBO Reregistration Eligibility Decision, EPA 2006]. PBO acts as a synergist by inhibiting the activity of a family of enzymes called cytochrome P450s. These enzymes have many functions, including breaking down toxic chemicals and transforming hormones. Indeed, the understanding in the industry is that synergists are critical components in insecticides that undergo detoxification by a P450 mechanism, which includes compositions that contain pyrethrins and pyrethroids as active agents. This understanding is apparent in the significant number of commercially available pyrethrin insecticides that contain a synergist in general use applications. Of the approximately 1,350 end-use products that contain pyrethrins, only a small percentage (<3%) are commercially available without PBO. As PBO is sold as a stand alone product, it is not known whether these few products are in fact being applied without PBO. Nevertheless, while such a synergist might increase insecticidal potency, the synergist usually adds considerable material and regulatory costs to the development, manufacture, and use of the insecticidal formulations.

Accordingly, alternative compositions containing pyrethrins that retain insecticidal and knockdown potency without the need for a synergist (such as PBO) are desirable. Further, given the increased awareness of the toxicity of certain substances, such compositions containing pyrethrins are especially valuable to the extent they include common non-toxic organic substances as carriers or additives to facilitate the use of the composition in the field.

### SUMMARY

In an aspect, the disclosure relates to a composition comprising pyrethrum and mineral oil. In some embodiments of this aspect, the composition comprises about 50% to about 99% mineral oil (by weight). In some embodiments of this aspect, the composition comprises about 0.1% to about 50% pyrethrum (by weight). In one embodiment of this aspect, the composition comprises about 10% pyrethrum and about 90% mineral oil (by weight).

In an aspect, the disclosure relates to a composition comprising a pyrethrin Manufacturing Use Product (MUP) and mineral oil. In some embodiments of this aspect, the composition comprises about 50% to about 99% mineral oil (by weight). In some embodiments of this aspect, the composition comprises about 0.1% to about 50% pyrethrin MUP (by weight). In some embodiments of this aspect the pyrethrin MUP is pyrethrin MUP 20, where MUP 20 refers to a MUP comprising about 20% pyrethrins by weight. In further embodiments of this aspect, the composition comprises about 25% pyrethrin MUP 20 and about 75% mineral oil (by weight).

In an aspect, the disclosure relates to a composition comprising pyrethrins and mineral oil. In some embodiments of this aspect, the composition comprises about 50% to about 99% mineral oil (by weight). In some embodiments of this aspect, the composition comprises about 0.1% to about 30% pyrethrins (by weight). In further embodiments of this aspect, the composition comprises about 5% pyrethrins and about 95% mineral oil (by weight).

In an aspect, the disclosure relates to a composition comprising mineral oil and one or more pyrethrin. In some embodiments of this aspect, the one or more pyrethrin comprises at least one or a combination of two or more naturally occurring pyrethrin esters selected from the group consisting of jasmolin-I, cinerin-I, pyrethrin-I, jasmolin-II, cinerin-II, and pyrethrin-II. In some embodiments of this aspect, the composition comprises about 50% to about 95% mineral oil (by weight). In some embodiments of this aspect, the composition comprises about 0.1% to about 30% pyrethrin (by weight). In some embodiments of this aspect, the composition comprises about 5% pyrethrin and about 95% mineral oil (by weight).

In an aspect, the disclosure relates to a composition comprising a pyrethroid and mineral oil. In some embodiments the pyrethroid comprises what is known as a Type I pyrethroid. In some embodiments, the pyrethroid comprises what is known as a Type II pyrethroid. In some embodiments, the pyrethroid is selected from the group consisting of acrinathrin, allethrin, benfluthrin, benzylnorthrin, bioallethrin, bioethanomethrin, bioresmethrin, bifenthrin, cyclethin, cycloprothrin, cyfluthrin, beta-cyfluthrin, gamma-cyhalothrin, lamdba-cyhalothrin, cypermethrin, alpha-cypermethrin, beta-cypermethrin, zeta-cypermethrin, cyphenothrin, deltamethrin, empenthrin, esbiothrin, esfenvalerate, etofenprox, fenfluthrin, fenpropathrin, fenvalerate, flucythrinate, flumethrin, imiprothin, isopyrethrin I, kadethrin, metofluthrin, permethrin, 1RS cis-permethrin, phenothrin, prallethrin, resmethrin, silafluofen, sumithrin (d-phenothrin), tau-fluvalinate, tefluthrin, tetramethrin, tralomethrin, transfluthrin, and isomers of these compounds. In some embodiments of this aspect, the composition comprises about 50% to about 99% mineral oil (by weight). In some embodiments of this aspect, the composition comprises about 0.1% to about 50% pyrethroid (by weight). In some embodiments of this aspect, the composition comprises about 5% pyrethroid and about 95% mineral oil (by weight).

In an aspect, the disclosure relates to a composition comprising (a) an extract from at least one flower selected from T. cinerariaefolium, C. cinerariaefolium, and C. coccineum, wherein the extract comprises pyrethrins, and (b) mineral oil. In some embodiments of this aspect, the composition comprises about 50% to about 99% mineral oil (by weight). In some embodiments of this aspect, the composition comprises about 0.1% to about 30% total pyrethrins (by weight). In some embodiments of this aspect, the composition comprises about 5% total pyrethrins and about 95% mineral oil (by weight).

In an aspect, the disclosure relates to a composition comprising pyrethrum, mineral oil, and wintergreen oil.

In an aspect, the disclosure relates to a composition comprising a pyrethrin MUP, mineral oil, and wintergreen oil.

In an aspect, the disclosure relates to a composition comprising pyrethrins, mineral oil, and wintergreen oil.

In an aspect, the disclosure relates to a composition comprising one or more pyrethrin, mineral oil, and wintergreen oil.

In an aspect, the disclosure relates to a composition comprising a pyrethroid, mineral oil, and wintergreen oil.

In an aspect, the disclosure relates to a composition comprising (a) an extract from at least one flower selected from T. cinerariaefolium, C. cinerariaefolium, or C. coccineum, wherein the extract comprises pyrethrins; (b) mineral oil; and (c) wintergreen oil.

In the aspects relating to compositions comprising both mineral oil and wintergreen oil, some embodiments provide a ratio of mineral oil to wintergreen oil as low as about 0.5 (i.e., about 0.5:1.0). In some embodiments of the aspects relating to compositions comprising both mineral oil and wintergreen oil, the compositions comprise about 25% to about 95% mineral oil (by weight). In some further embodiments of the aspects relating to compositions comprising both mineral oil and wintergreen oil, the compositions comprise about 25% to about 50% wintergreen oil (by weight).

In some embodiments of each of the above aspects, the composition excludes any synergist.

In some embodiments of each of the above aspects, the composition can further comprise an additional carrier, solvent, diluent, surfactant, emulsifier, dispersant, stabilizer, suspending agent, penetrant, antioxidant, UV-absorbing, or auxiliary agent.

In an aspect, the disclosure relates to an insecticide comprising a composition as disclosed herein.

In an aspect, the disclosure relates to a formulation comprising a composition as disclosed herein, wherein the formulation can be applied as an aerosol, a fog, or using a ULV sprayer.

In an aspect, the disclosure relates to a method for mosquito control comprising contacting a mosquito with an effective amount of a composition as disclosed herein. In some embodiments, the composition is applied in an amount effective to knockdown about 50% of the contacted mosquito population. In some embodiments, the composition is applied in an amount effective to kill about 95% of the contacted mosquito population.

The disclosure provides for other aspects and embodiments that will be apparent in light of the following detailed description.

### DETAILED DESCRIPTION

In a broad sense, the disclosure relates to insecticidal compositions and associated methods that are effective and selective against insects. Suitably, the insecticidal compositions pose little toxicology risk to plants and/or animals, or comparatively less risk relative to compositions that contain a synergist. The compositions can also be environmentally “green” as various components can be selected from compounds that have comparably less environmental impact. The inventors have developed and identified effective insecticidal compositions comprising pyrethrum, pyrethrins, one or more pyrethrin, or a pyrethroid in an oil-based carrier and mineral oil. Surprisingly, these compositions demonstrate efficacy without the need for any amount of a synergist compound. Thus, the disclosure provides compositions effective against insects (insecticides) such as mosquitoes, without the need or expense of adding a synergist compound, which is unexpected based on the state of the art in the industry. Accordingly, the synergists (e.g., PBO) used in many commercially available pyrethrin pesticides are no longer necessary when an insecticidal composition includes pyrethrins or a pyrethroid and mineral oil, such as in the compositions and related methods disclosed herein.

Chemistry of Pyrethrin Esters and Pyrethroids

The United States Environmental Protection Agency (the EPA) uses the terms “pyrethrum,” “pyrethrins,” and “pyrethroids” as follows:

“Pyrethrum” is a crude extract (and mixture of substances) derived from chrysanthemum flowers. It possesses insecticidal properties. Although no end-use products containing pyrethrum are currently registered with the EPA, the compositions described herein include embodiments using pyrethrum.

Refined pyrethrum is called “pyrethrins.” This refinement is intended to further isolate the insecticidal components of pyrethrum. The EPA regulates pyrethrins as one active ingredient; however, this refined extract contains a mixture of six pyrethrin esters. For example, the active ingredient in the Manufacturing Use Product (MUP) described below is what the EPA describes as “pyrethrins.” When analyzed using High Performance Liquid Chromotography the active ingredient is a mixture of Pyrethrins I and Pyrethrins II.

“Pyrethroids” are compounds synthesized to mimic the structure of pyrethrins, for example, to increase photostability and to enhance insecticidal activity. Pyrethroids are structurally similar to naturally occurring pyrethrin esters and act in a similar manner to pyrethrins.

As used herein, the term “pyrethrum” refers to a crude extract composition that is derived from chrysanthemum-like flowers primarily grown in Kenya, Tanzania, and Australia. (e.g., T. cinerariaefolium, C. cinerariaefolium, and C. coccineum) and comprises a mixture of the naturally occurring insecticidal ester compounds known as the “pyrethrins.” “Pyrethrins” is used herein as a collective term given to any combination of the six ester compounds (including refined pyrethrum) having the general Formula (I) and detailed in Table 1:

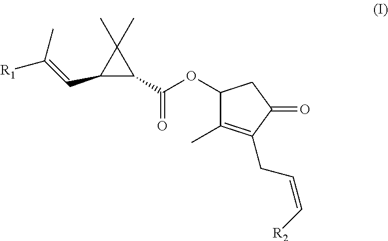

TABLE 1
Naturally Occurring Pyrethrin Esters

| Common Name | CAS Number | R₁ | R₂ |
|---|---|---|---|
| Pyrethrins I | | | |
| Jasmolin-I | 4466-14-2 | CH₃ | CH₂CH₃ |
| Cinerin-I | 25402-06-6 | CH₃ | CH₃ |
| Pyrethrin-I | 121-21-1 | CH₃ | CH═CH₂ |
| Pyrethrins II | | | |
| Jasmolin II | 1172-63-0 | CH₃OC(O) | CH₂CH₃ |
| Cinerin II | 121-20-0 | CH₃OC(O) | CH₃ |
| Pyrethrin II | 121-29-9 | CH₃OC(O) | CH═CH₂ |

The term “pyrethrin ester” or “pyrethrin” is used herein to refer to one or a combination of two or more of the naturally occurring compounds defined in Table 1.

While the terms “pyrethrins” and “pyrethrum” are sometimes used interchangeably, “pyrethrum” should be understood here to encompass crude extracts that contain pyrethrins. The pyrethrins in any given pyrethrum extract vary in relative amount, depending on factors such as the plant variety, where it is grown, and the time of harvest.

Because it is not currently commercially advantageous to separate and isolate individual pyrethrin esters from each other, the pyrethrins content in pyrethrum extract is typically analyzed for total content of pyrethrins. While variable, the current state of the art typically allows for the total pyrethrins (i.e., pyrethrins I and pyrethrins II) to constitute about 45 to 55% (by weight) of a pyrethrum extract. Besides the pesticidially active esters mentioned above, many plant constituents may be present in the pyrethrum extract. This extract is typically a high boiling, viscous liquid that is prone to oxidation in air, might be difficult to store for extended periods of time, and can be readily diluted in a vegetable-based oil carrier to provide a Manufacturing Use Product (MUP) containing about 20% pyrethrins. This provides for a longer shelf life and has the added advantage of being NOSB (National Organic Standards Board) compliant. Therefore, pyrethrins are approved for use in organic production operations. Pyrethrins are commercially available from several sources throughout the world and, in the United States, are available from several sources including the product sold under the trade name Pyganic® MUP 20 by MGK (Minneapolis, Minn.). Pyganic® MUP 20 contains about 20% pyrethrins by weight. When the term “MUP 20” is used herein it refers to a MUP comprising about 20% pyrethrins by weight and includes, but is not limited to, Pyganic® MUP 20.

The term “pyrethroid” is understood in the art to mean one or more synthetic compounds that act as an insecticide and are adapted from the chemical structure of Formula (I). The EPA has established two general classes of pyrethroids. Pyrethroids that include an α-cyano group (C—CN) bonded to the ester oxygen (see Formula (I)) are referred to as Type II pyrethroids, while pyrethroids lacking an α-cyano group are referred to as Type I pyrethroids. See, e.g., EPA Office of Pesticide Programs Memorandum “Pyrethroids: Evaluation of Data from Developmental Neurotoxicity Studies and Consideration of Comparison Sensitivity” (Jan. 20, 2010). Non-limiting examples of pyrethroids include acrinathrin, allethrin, benfluthrin, benzylnorthrin, bioallethrin, bioethanomethrin, bioresmethrin, bifenthrin, cyclethin, cycloprothrin, cyfluthrin, beta-cyfluthrin, gamma-cyhalothrin, lamdba-cyhalothrin, cypermethrin, alpha-cypermethrin, beta-cypermethrin, zeta-cypermethrin, cyphenothrin, deltamethrin, empenthrin, esbiothrin, esfenvalerate, etofenprox, fenfluthrin, fenpropathrin, fenvalerate, flucythrinate, flumethrin, imiprothin, isopyrethrin I, kadethrin, metofluthrin, permethrin, 1RS cis-permethrin, phenothrin, prallethrin, resmethrin, silafluofen, sumithrin (d-phenothrin), tau-fluvalinate, tefluthrin, tetramethrin, tralomethrin, transfluthrin, and isomers of these compounds.

Additional information regarding pyrethrum, pyrethrins, and pyrethroids can be found in various references, reviews, and fact sheets, for example, Pyrethrum Flowers: Production, Chemistry, Toxicology, and Uses. John E. Casida and Gary B. Quistad (eds.), Oxford University Press, 1995, and “Pyrethrins & Pyrethroids” 1998 Fact Sheet published by the National Pesticide Telecommunications Network (NPTN) at Oregon State University, Corvallis, Oreg.

“Mineral oil” as used herein relates to the commonly known product of the same name, which is an aliphatic solvent produced during the distillation of petroleum. Mineral oil is typically transparent and colorless and comprises complex mixtures of long-chain aliphatic (paraffinic) compounds often ranging is size from C₁₅-C₄₀. Mineral oils can include paraffinic oils (e.g., light mineral oil and heavy mineral oil), n-alkanes, naphthenic oils, cycloalkanes, aromatic oils, and aromatic hydrocarbons. Synonymous names for mineral oil can include “paraffin oil” or “white mineral oil” among other common names. Mineral oil is available from any number of commercial distributors (e.g., Brenntag, ProChem, Inc., etc.). Non-limiting examples of “mineral oil” include those identified by CAS registry numbers: 8012-95-1, 8020-83-5, 8042-47-5, 72623-84-8, 72623-86-0, 72623-87-1, 64741-88-4, 64741-89-5, 64742-54-7, 64742-55-8, 64742-56-9, and 64742-65-0.

A number of “synergist” compounds are used in commercially available insecticides and are known in the art. These compounds include the non-limiting example of piperonyl butoxide (PBO, discussed above). Embodiments of the disclosure provide compositions that do not include any amount of a synergist.

“Mosquito” is understood to refer to any specie of the ˜3,500 species of the insect that is commonly associated with and given the common name “mosquito.” Mosquitoes span 41 insect genera, including the non-limiting examples of Aedes, Culex, Anopheles (carrier of malaria), Coquillettidia, and Ochlerotatus. In embodiments described herein, a mosquito can refer to an adult mosquito or a larval mosquito, or both. Thus, some embodiments encompass methods or compositions wherein the insecticidal activity is as a mosquito “adulticide” or alternatively a mosquito “larvicide.”

Compositions

As noted above, the compositions disclosed herein are based and developed on the surprising and unexpected results that demonstrate that compositions comprising pyrethrins, pyrethrum, a pyrethrin, or a pyrethroid and mineral oil are effective insecticides, including in the absence of any amount of a synergist.

Accordingly, aspects of the disclosure provide a composition comprising pyrethrins, pyrethrum, one or more pyrethrin, or a pyrethroid and mineral oil. In some embodiments, the composition excludes the presence of a synergist. In embodiments of these aspects, the disclosure provides a composition comprising, consisting essentially of, or consisting of pyrethrins, pyrethrum, one or more pyrethrin, or a pyrethroid in an oil-based carrier and mineral oil. In yet other embodiments, the composition includes a combination of at least pyrethrins, pyrethrum, one or more pyrethrin, and/or at least one pyrethroid. In further embodiments the disclosure provides a composition comprising (a) an extract from at least one flower selected from T. cinerariaefolium, C. cinerariaefolium, and C. coccineum, wherein the extract comprises pyrethrins, and (b) mineral oil. In another embodiment, the disclosure provides a composition comprising, consisting essentially of, or consisting of pyrethrins, pyrethrum, one or more pyrethrin, or a pyrethroid, mineral oil, and wintergreen oil.

The amount of the active insecticidal agent (i.e., pyrethrins, pyrethrum, pyrethrin, or pyrethroid) in the composition can range broadly and can depend on the particular agent as well as the intended use of the composition (e.g., based on method of application and/or particular target insect). For example, as noted above current technology allows for a pyrethrum extract that contains as much as about 55% total pyrethrins (by weight). Thus, in embodiments, the composition can comprise an amount of pyrethrins or one or more pyrethrin in a range of about 0.1% to about 30% (by weight), about 1% to about 30%, about 1% to about 25%, about 1% to about 20%, about 1% to about 15%, about 1% to about 10%, about 1% to about 5%, about 5% to about 10%, about 5% to about 15%, about 5% to about 20%, about 5% to about 25%, or about 5% to about 30% (each range by weight). The recited weight percent ranges of pyrethrins or one or more pyrethrin should be understood to encompass all weight percent values falling within those ranges (e.g., “about 1% to about 10%” includes about 1%, 2%, 3%, 4%, 5%, 6%, 7%, 8%, 9%, and 10% as well as including fractions of those weight percent values (e.g., 5.1%, 5.2%, 5.3%, 5.4%, 5.5%, 5.6%, 5.7%, 5.8%, and 5.9%). In some embodiments, the composition can comprise an amount of pyrethrum, pyrethrin MUP, or pyrethroid in a range of about 0.1% to about 50% (by weight), about 1% to about 50%, about 1% to about 40%, about 5% to about 50%, about 5% to about 40%, about 5% to about 30%, about 5% to about 20%, about 5% to about 10%, about 10% to about 15%, or about 10% (each range by weight). The recited weight percent ranges of pyrethrum, pyrethrin MUP, or pyrethroid should be understood to encompass all weight percent values falling within those ranges (e.g., “about 10% to about 15%” includes about 10%, 11%, 12%, 13%, 14%, and 15% as well as including fractions of those weight percent values (e.g., 10.1%, 10.2%, 10.3%, 10.4%, 10.5%, 10.6%, 10.7%, 10.8%, and 10.9%). While the amount of insecticidal active agent can range broadly, for a composition to be registered and marketed as a “pesticide” within the United States for some uses (e.g., public health uses and pest control in residential structures) the EPA requires that a composition exhibits a 95% insect mortality at the lowest labeled rate. The EPA also regulates the upper limits of active agent(s) that can be used in practice in the environment. For example, pyrethrins are permitted at 0.0025 lbs/acre. Thus, in some embodiments, the compositions provided herein comprise an amount (e.g., weight %) of insecticidal active(s) (e.g., pyrethrins, pyrethrum, pyrethrin, and/or pyrethroid) that is suitably in a range that allows for at least some degree of insecticidal efficacy when the composition is used, while not necessarily meeting the EPA requirements for an insecticide for certain uses (i.e., more than 0%, but less that 95% insect mortality rate). In some embodiments, the amount (e.g., weight %) of insecticidal active(s) (e.g., pyrethrins, pyrethrum, pyrethrin, and/or pyrethroid) in the composition meets or exceeds the EPA requirements for an insecticide suitable for certain uses and in certain applications (e.g., sold as a concentrate or ready-to-use product). In some embodiments the composition comprises pyrethrins, pyrethrum, pyrethrin, and/or pyrethroids at about 5% (by weight).

One skilled in the art can select an appropriate amount of insecticidal agent and mineral oil depending on the type of insect as well as the particular method of application. In certain embodiments, an amount of insecticidal agent can be selected such that the composition balances the insecticidal efficacy with the cost of the insecticidal agent as well as balance risk of undesirable side effects (e.g., animal (fish or mammal) toxicity and/or environmental impact).

In some embodiments, the composition can include about 25% to about 99%, about 30% to about 99%, about 40% to about 99%, about 50% to about 99%, about 60% to about 99%, about 70% to about 99%, about 70% to about 95%, about 70% to about 90%, about 70% to about 85%, or about 70% to about 80% mineral oil. The recited weight percent ranges of mineral oil should be understood to encompass all weight percent values falling within those ranges (e.g., “about 70% to about 80%” includes about 71%, 72%, 73%, 74%, 75%, 76%, 77%, 78%, 79%, 80%, as well as including fractions of those weight percent values (e.g., 71.1%, 71.2%, 71.3%, 71.4%, 71.5%, 71.6%, 71.7%, 71.8%, and 71.9%). In some embodiments, the composition can include one or more carriers and/or diluents in addition to the mineral oil such as, for example, any solid or liquid carrier or diluent that is commonly used in pesticidal, insecticidal, agricultural or horticultural compositions. Suitably, any included additional carrier or diluent will not reduce the insecticidal efficacy of the composition, relative to the efficacy of the composition in the absence of the additional component. Carriers and diluents can include, for example, solvents (e.g., water, alcohols, acids, and esters); vegetable and/or plant-based oils as well as ester derivatives thereof (e.g., wintergreen oil, cedarwood oil, rosemary oil, peppermint oil, geraniol, rose oil, palmarosa oil, citronella oil, citrus oils (e.g., lemon, lime, and orange), dillweed oil, corn oil, sesame oil, soybean oil, palm oil, vegetable oil, olive oil, peanut oil, and canola oil). The composition can include varying amounts of other components such as, for example, surfactants (e.g., non-ionic, anionic, cationic, and zwitterionic surfactants); fatty acids and fatty acid esters (e.g., methyl palmitate/oleate/linoleate); and other auxiliary ingredients such as, for example, emulsifiers, dispersants, stabilizers, suspending agents, penetrants, coloring agents/dyes, and fragrances, as necessary or desired. Components other than the insecticidal active agent(s) and the mineral oil can be included in the compositions in any amount as long as the composition has some amount of insecticidal efficacy.

In some embodiments, the disclosure provides a composition comprising consisting essentially of, or consisting of pyrethrins, pyrethrum, one or more pyrethrin, or a pyrethroid, mineral oil, and wintergreen oil. In further embodiments, the composition includes mineral oil and wintergreen oil in a ratio (mineral oil to wintergreen oil) of about 10.0 to about 0.5, about 5.0 to about 0.5, about 2.0 to about 0.5, or about 1.5 to about 0.6. In some embodiments the composition comprises about 5% to about 50% (e.g., about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or about 50%) wintergreen oil. Several non-limiting embodiments of compositions that comprise wintergreen oil are detailed below in Table 8.

Embodiments include commercially useful formulations or “ready-to-use” application forms. In such formulations, the composition can be suitably provided as a mixture with other active compounds, for example, various additional insecticides, pesticides, fungicides, anti-microbials, and/or herbicides, as well as plant growth regulators, insect repellents, attractants, fertilizers and/or fragrances, to expand the applicability of the insecticidal composition described herein. Embodiments provide for the compositions manufactured as formulations that are useful for mosquito control. In some embodiments, the composition can be formulated as an emulsion, a liquid concentrate, a sol (flowable agent), an aerosol (e.g., fogger), a liquid for ultra low volume (ULV) application, or the like, by any standard or conventional methods for mixing and manufacturing such formulations such as, for example, admixing pyrethrum and an amount of mineral oil optionally with any suitable additional inert ingredient that is used as a carrier, solvent, diluent, emulsifier, dispersant, stabilizers suspending agent, or penetrant. The addition of these materials would depend on the active ingredient and the type of formulation and how it is intended to be applied.

In embodiments, the composition can be formulated for application or delivery as an aerosol or a fog wherein the composition allows for the formation of droplets having an average diameter of about 1 μm to about 30 μm. Suitable compositions for such a formulation typically should have a viscosity that allows for the composition to atomize, but not be so thick as to clog the nozzle. Such viscosities can vary and be readily determined by one of skill in the art; however, a non-limiting common minimum viscosity is about 70 centistokes (cts).

In some embodiments, the formulation suitably comprises a concentration of insectidical active compound or composition (e.g., pyrethrins, pyrethrum, one or more pyrethrin, and/or a pyrethroid) that is adequate for insecticidal activity when applied in a volume from about 0.5 to about 2.0 fluid ounces per acre such as in an ultra low volume (ULV) application.

In some embodiments, the composition can comprise one or more compounds that can increase the long-term stability of the pyrethrins, pyrethrum, one or more pyrethrin, and/or pyrethroid in the composition. Thus, some embodiments may include an antioxidant to provide stabilization to oxidation and/or a UV light absorber to provide stabilization to light exposure. Such compounds are known in the art. Packaging and/or storage containers for the compositions described herein can be selected to provide protection from degradation of actives (e.g., pyrethrins, one or more pyrethrin, or pyrethroid) by oxygen and light exposure (e.g., vacuum packaging, inert atmosphere, deoxygenated solvents, and opaque/colored containers).

As previously described, some embodiments provide the composition as a product that is approved for use in organic production operations. In such embodiments, the composition can consist of or consist essentially of pyrethrum, pyrethrins, or one or more pyrethrin in a vegetable-based oil, and mineral oil. Some embodiments provide for a composition that includes pyrethrum, pyrethrins, or one or more pyrethrin, and mineral oil, and further comprises components that are NOSB compliant.

Methods

In an aspect, the disclosure provides a method for mosquito control comprising contacting a mosquito with an amount of any of the compositions herein described. In some embodiments, the method comprises contacting a mosquito with an amount of a composition comprising, consisting essentially of, or consisting of a pyrethrum, pyrethrins, one or more pyrethrin, or pyrethroid, and mineral oil effective to knockdown about 50% of the contacted mosquito population. In some embodiments, the method comprises contacting a mosquito with an amount of a composition comprising, consisting essentially of, or consisting of pyrethrum, pyrethrins, one or more pyrethrin, or pyrethroid, and mineral oil effective to provide about 95% mosquito mortality at the lowest labeled rate. In some embodiments, the method comprises contacting a mosquito with an amount of a composition comprising or consisting essentially of pyrethrum, pyrethrins, one or more pyrethrin, or pyrethroid, and mineral oil, wherein the composition excludes a synergist. In some embodiments, the method comprises contacting a mosquito with an amount of a composition comprising, consisting essentially of, or consisting of pyrethrum, pyrethrins, one or more pyrethrin, or pyrethroid, and mineral oil, wherein the composition contains about 0.1% to about 30% (by weight) of pyrethrum, pyrethrins, one or more pyrethrin, or pyrethroid. In some embodiments, the method includes a composition comprising about 5% (by weight) of pyrethrum, pyrethrins, one or more pyrethrin, or pyrethroid.

In some embodiments, the methods described herein can comprise any known route, apparatus, and/or mechanism for the delivery or application of the compositions and formulations. In some embodiments, the method comprises a sprayer. Traditional pesticide sprayers in the pest control markets are typically operated manually or electrically or are gas-controlled and use maximum pressures ranging from 15 to 500 psi generating flow rates from 5 gpm to 40 gpm. In other embodiments, the methods disclosed herein comprise the use of the compositions and/or formulations in combination with any low volume environmental pest control device(s) such as, for example, ultra low volume (ULV) machines. Such combinations are useful in methods for mosquito control as well as other flying insects (e.g., flies, gnats, and flying ants) wherein contacting the insect with a low volume of the composition is possible and/or desirable. ULV machines suitably use low volume of material, for example at rates of about one gallon per hour (or ounces per minute), and typically utilize artificial wind velocities such as from, for example, an air source (e.g., pump or compressor) to break down and distribute the composition/formulation into a cold fog (suitably having average droplet particle sizes of about 1-30 μm). Any standard ground ULV equipment used for adult mosquito control such as, for example, a system including a (CETI) Grizzly aerosol generator can be used in the methods described herein. A general ULV system includes a tank for the composition (e.g., insecticide), a transport system (e.g., a pump or pressurized tank), a flow control device, and a nozzle that atomizes the composition. Typically, ULV machines do not compress droplets. Rather, they often use a venture siphoning system, and can induce an artificial energizing of the droplets by adding an electrical current to the liquid (e.g., through the use an electrode located at the application tip. See U.S. Pat. No. 3,516,608 (Bowen et al.) incorporated herein by reference).

Methods for Making Compositions

The compositions can be generally prepared by any appropriate manufacturing processes and using any appropriate manufacturing equipment such as is known in the art. Suitably, the compositions can be prepared by combining the various components (e.g., pyrethrum, pyrethrins, one or more pyrethrin, and/or pyrethroid, and mineral oil) in an appropriate vessel (considering vessel size, amount of composition to be made and reactivity of components) with mixing (e.g., stirring) until a uniform or homogeneous composition is achieved. The various composition components can be added sequentially, with stirring between each addition to ensure dissolution and/or dispersion of the previous component. For example, a composition can be prepared by first adding mineral oil to a mixing vessel, adding pyrethrum, pyrethrins, one or more pyrethrin, and/or pyrethroid to the mineral oil with stirring until the components fully disperse. This may be followed by addition of one or more additional components (e.g., solvents, diluents, and carriers) with stirring to provide a homogeneous composition.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including but not limited to”) unless otherwise noted. All methods described herein can be performed in any suitable order unless otherwise indicated herein or otherwise clearly contradicted by context. The use of any and all examples, or exemplary language (e.g., “such as”) provided herein, is intended merely to illustrate aspects and embodiments of the disclosure and does not limit the scope of the claims.

### EXAMPLES

### Materials and Methods

Reagents.

Pyrethrins were supplied as a 20% Manufacturing Use Product or “MUP” (Pyganic® MUP 20, MGK (Minneapolis, Minn.)). Mineral oil was supplied by Brenntag Great Lakes, LLC. Diluents were supplied by Stepan Company, Procter & Gamble Chemicals, and Vertec Biosolvents. Piperonyl butoxide (PBO) was purchased from Takasago International Corp. Essential oils or botanicals were purchased from The Good Scents Company, The Lebermuth Company, and Takasago International Corporation.

Topical Bioassay Method.

Adult mosquitoes were reared on 10% sucrose solution in an insectary maintained at 27° C., 45% RH and 12/12 hour light/dark photoperiod. Adult female Aedes aegypti mosquitoes were segregated in 18″×18″ screen cages based on date of eclosion, therefore the exact age of the mosquitoes were known for bioassays.

Ten female mosquitoes, aged four to six days after eclosion, were aspirated out of their respective cage and into a small glass jar. The mosquitoes were then anesthetized with CO₂ gas for 30 seconds. After the adults were anesthetized, they were quickly placed on a plastic platform for treatment application. Treatments were serially diluted (using a BrandTech Scientific Transferpette S pipette (100-1000 μL), labeled centrifuge tubes, and a vortex mixer) from stocks of Pyganic® MUP 20 using technical grade acetone as the diluent to concentrations as indicated for each treatment solution. A treatment solution may contain additional ingredients as indicated for each study.

Using a Hamilton PB00-1 Repeating Dispenser with a Hamilton 25 Microliter Syringe, 0.5 μl of each treatment solution was applied to the thorax of each mosquito. Immediately following the application of the treatment, the mosquitoes were gently transferred into a clean paper cup and covered with screen. The mesh screen prevented the mosquitoes from escaping and allowed the specimens to be viewed for ratings. A cotton ball soaked with 10% sucrose solution was inserted into a side hole of each cup for hydration and nourishment. Each treatment variable in the study was replicated three times using separate cups for each replication.

In each study, an untreated control and an acetone treated control was included to ensure that the CO₂ gas and the acetone diluent had no lethal effect on the mosquitoes. The untreated controls treatments were anesthetized for 30 seconds and gently transferred to the paper cups. The acetone treated control was treated exactly as described above except that the solution applied to each mosquito was undiluted acetone.

The condition of the mosquitoes in each cup was recorded at one hour and 24 hours after initial treatment. The condition classifications used were 1) alive and flying, 2) alive and unable to fly, or 3) dead. The percent mortality for each replicate and the mean percent mortality for each treatment and evaluation time were calculated.

Statistical Analysis.

Where indicated, the mortality data were subjected to probit analysis using the Statistical Analysis System Version 9.1 program PROC PROBIT (SAS Institute (2003) PROC user's manual, version 9.1. SAS Institute, Cary, N.C.). When comparing LD₅₀ values, a failure of 95% confidence limits to overlap was used to determined significant differences between bioassays with and without synergists (Robertson and Preisler, (1992) “Pesticide bioassay with arthropods.” CRC Press Inc., Boca Raton, Fla.). In all cases the likelihood ratio (L.R.) or Pearson chi-square goodness-of-fit values indicated that the data adequately conformed to the probit model (ibid).

Mosquito Stocks for Field Trials.

The Culex and Aedes adult mosquitoes for the field trial were reared from pupae shipped overnight from the Clarke Technical Center Insectary to the Florida Research Laboratory. Mosquitoes were fed a 10% sugar water solution upon emergence and were maintained on 10% sugar water throughout the field trials. For laboratory experiments and assays, the desired number of adult mosquitoes (typically about three to seven days old) were isolated and maintained on 10% sugar water solution.

### Example 1

### Pyrethrins and Mineral Oil Compositions

For preparation of a typical 10 g insecticide composition for biological screening 2.5 g Pyganic® MUP (containing 20% active as pyrethrins) was added to a 25 mL glass vial containing 7.5 g mineral oil and was mixed to homogeneity using a laboratory Vortex mixer at ambient temperature. The resulting composition contained about 75% mineral oil and 25% Pyganic® MUP and provided a 5% pyrethrins (active ingredient) formulation.

The initially observed insecticidal efficacy of the PBO-free pyrethrins and mineral oil compositions were unexpected. An initial hypothesis regarding the efficacy was that the particular MUP lot had an unusually potent pyrethrins mixture. To ensure that the insecticidal activity of the compositions was not due to any lot variance of the pyrethrum source, standard formulations were prepared (as above) from four different lots of the MUP and one lot of mineral oil, and were assessed for insecticidal activity (topical assay). The data indicated that there was no significant variance of pyrethrum activity between the four different lots (assessed with one hour knockdown and 24 hour mortality numbers).

TABLE 2
LD₅₀ results for four different lots of Pyganic ® MUP
20 formulated with the same lot of mineral oil against virgin female
Aedes aegypti adults using the topical bioassay method

| | LD₅₀ ¹ | 95% FL |
|---|---|---|
| Sample | μg/mosquito | μg/mosquito |
| 1 | 0.001 a | 0.001-0.0018 a |
| 2 | 0.001 a | 0.008-0.001 a |
| 3 | 0.001 a | 0.008-0.001 a |
| 4 | 0.001 a | 0.0004-0.001 a |

¹ LD₅₀ followed by the same letters are not significantly different (P = 0.05) based on of 95% fiducial limit overlaps.

Further, to ensure that the insecticidal activity of the compositions was not due to any lot variance of the mineral oil source, standard formulations (as above) were prepared from four different lots of mineral oil (and one lot of Pyganic® MUP 20) and were assessed for insecticidal activity (topical assay). The data (not shown) indicated that there was no significant variance of pyrethrum activity between the four different lots (assessed with one hour knockdown and 24 hour mortality numbers).

The storage stability of the pyrethrins and mineral oil composition was assessed for samples stored over a two week period in a 50° C. oven. The stability of the composition was assessed in parallel and relative to a composition that further included a synergist (PBO). Pyrethrins content was determined using a weight percent assay at three separate time points: zero (initial), one week, and two weeks for each sample. This content was determined by using a Perkin Elmer HPLC according to Clarke Analytical Method PY001. The results indicated that the pyrethrins in both samples did not degrade over the two week time course (100.45% of initial for the mineral oil sample; 98.69% of the initial for the mineral oil+PBO sample).

### Example 2

### Pyrethrins and Mineral Oil with Various Diluents

A series of compositions was prepared based on the observed properties of the combination of mineral oil and pyrethrins. These compositions were formulated to include an additional diluent. A series of 10 g samples was generated according to the weight percentages described below.

The third component (diluent) was added to the composition at a 1:1 ratio relative to the weight percentage of Pyganic® MUP20. Samples 9-14 included base components of 25.39% Pyganic® MUP20 (per Certificate of Analysis, pyrethrins content was 19.7%) and 49.22% mineral oil, then individually 25.39% of isopropyl myristate (sample 9); wintergreen oil (sample 10); Procter & Gamble C-1618 (sample 11); Stepan C-65 (sample 12); d-limonene (sample 13); or butyl lactate (sample 14). For simplicity of description and without being limited to any particular function, the variable components were termed as diluents.

TABLE 3
Bioassay results for additional diluents formulated to contain 5.0%
pyrethrins, mineral oil, and a diluent (1X) assessed for one hour
knockdown (KD) and 24 hour mortality (MT) applied at discriminating
doses of 0.001 μg/insect (LD₅₀) and 0.002 μg/insect (LD₉₅)

| | |
|---|---|
| LD₅₀ | LD₉₅ |

| | 1 hour | 24 hour | 1 hour | 24 hour |
|---|---|---|---|---|
| Sample | % KD | % MT | % KD | % MT |
| 9 | 100 | 77 | 100 | 93 |
| 10 | 90 | 53 | 100 | 97 |
| 11 | 87 | 7 | 97 | 70 |
| 12 | 100 | 40 | 100 | 87 |
| 13 | 80 | 10 | 100 | 80 |
| 14 | 87 | 30 | 100 | 47 |

A further series of compositions was prepared in which the amount of added third component was increased to a 2:1 ratio relative to the weight percentage of Pyganic® MUP20. Samples 15-20 included base components of 25.39% Pyganic® MUP20 and 23.83% mineral oil, then individually 50.78% of isopropyl myristate (sample 15); wintergreen oil (sample 16); Procter & Gamble C-1618 (sample 17); Stepan C-65 (sample 18); d-limonene (sample 19); or butyl lactate (sample 20).

TABLE 4
Bioassay results for additional diluents formulated to contain
5.0% pyrethrins, mineral oil, and a diluent (2X) assessed
for one hour knockdown (KD) and 24 hour mortality (MT) applied at
discriminating dose of 0.001 μg/insect (LD₅₀)

LD₅₀

| Sample | 1 hour % KD | 24 hour % MT |
|---|---|---|
| 15 | 97 | 37 |
| 16 | 90 | 47 |
| 17 | 87 | 33 |
| 18 | 93 | 30 |
| 19 | 93 | 43 |
| 20 | 97 | 57 |

A final series of compositions was prepared in which the amount of added third component was increased to a 2:1 ratio relative to the weight percentage of Pyganic® MUP. Samples 21-28 included base components of 25.39% Pyganic® MUP20 and 23.83% mineral oil, then individually 50.78% of oleic acid (sample 21); Stepan C-42 (sample 22); Proctor and Gamble CE-1270 (sample 23); Procter & Gamble CE-1295 (sample 24); Steposol ME (sample 25); Soygold 1000 (sample 26); Soygold 1500 (sample 27); or Vertecbio Gold #1 (sample 28).

TABLE 5
Bioassay results for additional diluents formulated to contain 5.0%
pyrethrins, mineral oil, and a diluent (2X) assessed for one hour
knockdown (KD) and 24 hour mortality (MT) applied at the discriminating
doses of 0.001 μg/insect (LD₅₀) and 0.002 μg/insect (LD₉₅)

| | |
|---|---|
| LD₅₀ | LD₉₅ |

| | 1 hour | 24 hour | 1 hour | 24 hour |
|---|---|---|---|---|
| Sample | % KD | % MT | % KD | % MT |
| 21 | 83 | 40 | 100 | 97 |
| 22 | 87 | 23 | 100 | 80 |
| 23 | 90 | 30 | 97 | 90 |
| 24 | 83 | 30 | 100 | 80 |
| 25 | 87 | 40 | 100 | 73 |
| 26 | 83 | 23 | 97 | 87 |
| 27 | 87 | 43 | 100 | 90 |
| 28 | 87 | 43 | 97 | 83 |

### Example 3

### Pyrethrins and Mineral Oil with Various Botanicals

A series of compositions was prepared that included additional components generally derived from botanical sources. Samples 29-32 included base components of 25.39% Pyganic® MUP20 and 73.61% mineral oil, then individually 1.0% of cedarwood oil (Sample 29); rosemary oil (Sample 30); peppermint oil (Sample 31); or geraniol (Sample 32).

TABLE 6
Bioassay results for compositions formulated to contain
5.0% pyrethrins, mineral oil, and 1% of a botanical assessed for one
hour knockdown (KD) and 24 hour mortality (MT) applied at
discriminating doses of 0.001 μg/insect (LD₅₀) and 0.002 μg/insect (LD₉₅)

| | |
|---|---|
| LD₅₀ | LD₉₅ |

| | 1 hour | 24 hour | 1 hour | 24 hour |
|---|---|---|---|---|
| Sample | % KD | % MT | % KD | % MT |
| 29 | 90 | 20 | 100 | 80 |
| 30 | 100 | 33 | 100 | 83 |
| 31 | 100 | 47 | 100 | 83 |
| 32 | 100 | 40 | 100 | 87 |

Another series of compositions was prepared that combined d-limonene (a solvent) with the pyrethrins and mineral oil and a fourth additional component generally derived from botanical sources. Samples 33-38 included base components of 25.39% Pyganic® MUP and 24.00% mineral oil with 40.61% d-limonene and then individually 10.0% of cedarwood oil from Virginia (sample 33); lavandin oil (sample 34); coriander seed oil (sample 35); eucalyptus citriadora oil (sample 36); eucalyptus globulus oil (sample 37); or cedarwood oil from Texas (sample 38).

TABLE 7
Bioassay results for compositions formulated to contain 5.0% pyrethrins,
mineral oil, d-limonene and 10.0% botanical assessed for one hour
knockdown (KD) and 24 hour mortality (MT) applied at discriminating
doses of 0.001 μg/insect (LD₅₀) and 0.002 μg/insect (LD₉₅)

| | |
|---|---|
| LD₅₀ | LD₉₅ |

| | 1 hour | 24 hour | 1 hour | 24 hour |
|---|---|---|---|---|
| Sample | % KD | % MT | % KD | % MT |
| 33 | 97 | 80 | 100 | 90 |
| 34 | 97 | 57 | 100 | 100 |
| 35 | 100 | 70 | 100 | 97 |
| 36 | 93 | 23 | 97 | 90 |
| 37 | 90 | 33 | 100 | 80 |
| 38 | 100 | 87 | 100 | 100 |

### Example 4

### Pyrethrins and Mineral Oil with Wintergreen Oil

Because wintergreen oil was found to be an efficacious diluent in the composition of pyrethrins and mineral oil, a formulation study was conducted to evaluate its efficacy. Eleven samples were generated that included 5% pyrethrins and varying amounts of mineral oil and wintergreen oil (Table 8). The insecticidal activity of each of the eleven compositions was assessed using the topical bioassay method.

TABLE 8
Bioassay results for compositions formulated to contain 5.0%
pyrethrins and varying ratios of mineral oil/wintergreen oil and
assessed for one hour knockdown (KD) and 24 hour mortality (MT)
applied at discriminating doses of 0.001 μg/insect (LD₅₀)
and 0.002 μg/insect (LD₉₅)

| | | Winter- | | LD₅₀ | | LD₉₅ | |
|---|---|---|---|---|---|---|---|
| Sam- | Mineral | green | | 1 hour | 24 hour | 1 hour | 24 hour |
| ple | Oil | Oil | Ratio | % KD | % MT | % KD | % KD |
| 1 | 44.61 | 30.00 | 1.4870 | 100 | 70 | 100 | 93 |
| 2 | 39.41 | 35.20 | 1.1196 | 93 | 43 | 100 | 90 |
| 3 | 39.21 | 35.40 | 1.1076 | 100 | 100 | 70 | 97 |
| 4 | 39.01 | 35.60 | 1.0958 | 100 | 100 | 50 | 100 |
| 5 | 38.81 | 35.80 | 1.0841 | 100 | 100 | 50 | 100 |
| 6 | 38.61 | 36.00 | 1.0725 | 93 | 60 | 100 | 100 |
| 7 | 37.61 | 37.00 | 1.0165 | 100 | 70 | 100 | 93 |
| 8 | 36.61 | 38.00 | 0.9634 | 100 | 63 | 100 | 100 |
| 9 | 35.61 | 39.00 | 0.9131 | 97 | 70 | 100 | 97 |
| 10 | 34.61 | 40.00 | 0.8653 | 97 | 63 | 100 | 100 |
| 11 | 29.61 | 45.00 | 0.6580 | 97 | 57 | 100 | 100 |

As the results in Table 8 demonstrate, the presence of an additional wintergreen oil component (e.g., as a carrier, diluent, or solvent) in a ratio ranging from about 1.5 to about 0.6 (mineral oil to wintergreen oil) provides for an effective insecticide formulation such as, for example, for mosquito control.

### Example 5

### Insecticidal Activity of PBO

To test the insecticidal efficacy of a commonly used synergist compound piperonyl butoxide (PBO) on adult mosquitoes, a series of experiments were performed that included applying serial dilutions of PBO (in acetone) topically to adult Aedes aegypti mosquitoes.

A stock PBO solution (solution #1) was made by dissolving 10 mg PBO in 100 mL of acetone. This provided a solution of PBO that can be applied at a concentration of 3.3×10⁻⁵ μg/mg of mosquito (assuming a 3.0 mg weight for an average adult A. aegypti mosquito). A series of four diluted solutions were generated from this stock solution, using 1.0 mL stock in 10 mL acetone (solution #2 at 3.3×10⁻⁶ μg/mg); 0.5 mL stock in 10 mL acetone (solution #3 at 1.65×10⁻⁶ μg/mg); 0.1 mL stock in 10 mL acetone (solution #4 at 3.3×10⁻⁷ μg/mg); and 0.05 mL stock in 10 mL acetone (solution #5 at 1.65×10⁻⁷ μg/mg).

The solutions were topically applied to ten adult mosquitoes (from five to seven days old) in an amount of 1.0 μL/mosquito. Acetone and carbon dioxide (CO₂) controls were run in parallel. Five replications were performed for each solution or control, and the overall experiment was duplicated. While two replicates in one of the trials for PBO solution number 1 (highest concentration) showed a 60% mortality rate, the remaining eight replicates between the two trials averaged 10% mortality. Thus, the one hour knockdown and mortality data as well as the 24 hour knockdown and mortality data (not shown) indicated that none of the PBO solutions provided any significant adulticide effect relative to the controls.

### Example 6

### Insecticidal Field Assay

A 5 kg batch of 5% pyrethrins and mineral oil composition was prepared in a stainless steel liquid mixing vessel using a laboratory overhead stirrer equipped with an anchor stirring blade.

Field bioassays were conducted at Lake Wales Airport in Lake Wales, Fla. to determine the efficacy of the mineral oil and pyrethrum (5%) ULV formulation in open field caged trials against adult Aedes aegypti and Culex quinquefasciatus mosquitoes. The caged trials were conducted using mosquitoes that were adult females (two to three days old) reared from pupae (see above). Mosquitoes were mouth aspirated using aspirators with HEPA filters into standard cylindrical cardboard spray cages (14.4 cm diameter; Townzen, K. R., et al. 1973). Mosquito cages were then placed in sealed containers and transported to the field site for the trials.

The open field application was performed as a ULV aerosol. Briefly, a truck-mounted Grizzly ULV aerosol applicator equipped with smart flow was calibrated to deliver the appropriate application rates (below) and sprayed at about 10 mph. The composition was applied using standard ground ULV equipment commonly used for adult mosquito control, (CETI) Grizzly aerosol generator equipped with an 18 HP Briggs & Stratton IC engine coupled to a 350-CFM ROOTS rotary positive displacement blower. All equipment was calibrated to deliver 0.5 oz and 0.75 oz undiluted composition per acre. Air pressure was adjusted to deliver a spray droplet VMD below 20 microns.

The study included two open field caged trials at two application rates, 0.5 oz/acre and 0.75 oz/acre. In the 0.5 oz/acre trial, two cages at each distance and location each contained a different species. In the 0.75 oz/acre trial, one cage was used for each distance and location with A. aegypti. All mosquitoes were visually inspected for accuracy of age and species identification.

The field site had an approximate total area of ten acres of grassy, open field. Spray cages were placed on stakes (5 foot high). The stakes were placed at 100, 200, and 300 feet down-wind and 100 feet apart at a 90° angle from the spray line. A total of 19 spray cages (18 treated and one untreated control) were used in each replicate for the 0.5 oz/acre trial. There were two cages containing Aedes or Culex, one each species used at the stake locations of the 0.5 oz/acre trial. A total of ten spray cages containing Aedes (nine treated, one untreated control) were used in each replicate for the 0.75 oz/acre trial. Three replications were made for each trial. After each replicate, the treated mosquitoes were allowed ten minutes exposure and then transferred to clean holding cages for knockdown and mortality monitoring. Mosquitoes were fed a 10% sugar water solution and monitored at one hour for knockdown and 24 hours for mortality. Mosquitoes were considered knocked down or dead if they remained moribund after receiving a slight puff of air from the observer. Any movement by a mosquito outside of this observation required the observer to record the individual as alive. Summary data is reported in Tables 9, 10, and 11.

Teflon coated slides were used to sample the spray cloud at 100, 200, and 300 feet down-wind of the spray tangent using John Hock Rotary Slide Impingers. Droplets were collected in each replicate and analyzed using a spread factor of 0.60 (Anderson, et al., 1971).

The data indicates that the composition was effective at the application rates of 0.5 oz and 0.75 oz per acre. The resulting percent mortality for each trial showed there were no statistical differences between the cage distances from the spray point of origin.

TABLE 9
Aedes aegypti summary data for a 5% (wt) pyrethrins
and mineral oil composition applied at 0.5 oz/acre

| | Aedes aegypti | | | | | |
|---|---|---|---|---|---|---|
| | 1 Hour Knockdown | | | 24 Hour Mortality | | |
| | Mean | | | Mean | | |
| | Knockdown¹ | | % | Mortality¹ | | % |
| Distance | (SE) | | Knockdown | (SE) | | Mortality |
| 100 feet | 60.0 | (2.6) a | 98.9% | 58.3 | (1.76) a | 96.2% |
| 200 feet | 59.3 | (0.67) a | 98.3% | 56.0 | (2.0) a | 92.8% |
| 300 feet | 61.0 | (1.0) a | 97.3% | 54.67 | (0.88) a | 87.2% |
| Untreated | 0.0 | (0.0) b | 0.0% | 0.0 | (0.0) b | 0.0% |

¹Means followed by the same letter are not significantly different P < 0.005); mean separation by LSD (a = 0.05), within each challenge set.

TABLE 10
Culex quinquefasciatusi summary data for 5% (wt) pyrethrins
and mineral oil composition applied at 0.5 oz/acre

| | Culex quinquefasciatus | | | | |
|---|---|---|---|---|---|
| | 1 Hour Knockdown | | 24 Hour Mortality | | |
| | Mean | | Mean | | |
| | Knockdown¹ | % | Mortality¹ | | % |
| Distance | (SE) | Knockdown | (SE) | | Mortality |
| 100 feet | 46.67 (2.33) a | 100% | 46.33 | (2.6) a | 99.3% |
| 200 feet | 47.33 (4.26) a | 98.6% | 45.0 | (3.8) a | 93.8% |
| 300 feet | 42.67 (2.33) a | 97.7% | 41.0 | (1.0) a | 93.9% |
| Untreated | 0.067 (0.33) b | 3.33% | 0.067 | (0.33) b | 3.33% |

¹Means followed by the same letter are not significantly different P < 0.005); mean separation by LSD (a = 0.05), within each challenge set.

TABLE 11
Aedes aegypti summary data for 5% (wt) pyrethrins
and mineral oil composition applied at 0.75 oz/acre

| | Aedes aegypti | | | | | |
|---|---|---|---|---|---|---|
| | 1 Hour Knockdown | | | 24 Hour Mortality | | |
| | Mean | | | Mean | | |
| | Knockdown¹ | | % | Mortality¹ | | % |
| Distance | (SE) | | Knockdown | (SE) | | Mortality |
| 100 feet | 60.0 | (1.0) a | 98.4% | 60.0 | (1.15) a | 98.4% |
| 200 feet | 53.67 | (4.84) a | 91.0% | 52.67 | (5.36) a | 89.3% |
| 300 feet | 60.33 | (1.67) a | 96.8% | 59.67 | (2.33) a | 95.7% |
| Untreated | 0.0 | (0.0) b | 0.0% | 0.0 | (0.0) b | 0.0% |

¹Means followed by the same letter are not significantly different P < 0.005); mean separation by LSD (a = 0.05), within each challenge set.

Accordingly, the compositions described herein can be manufactured on large scale and have demonstrated insecticidal efficacy in open field studies.

1. A composition comprising pyrethrum and mineral oil.

2. The composition of claim 1, wherein the composition excludes any synergist.

3. The composition of claim 1, comprising about 50% to about 99% mineral oil (by weight).

4. The composition of claim 1, comprising about 0.1% to about 50% pyrethrum (by weight).

5. The composition of claim 1, comprising about 10% pyrethrum and about 90% mineral oil (by weight).

6. The composition of claim 5, wherein the composition consists essentially of pyrethrum and mineral oil.

7. A composition comprising pyrethrin MUP and mineral oil.

8. The composition of claim 7, wherein the composition excludes any synergist.

9. The composition of claim 7, comprising about 50% to about 99% mineral oil (by weight).

10. The composition of claim 7, comprising about 0.1% to about 50% pyrethrin MUP (by weight), wherein the pyrethrin MUP is pyrethrin MUP 20.

11. The composition of claim 7, comprising about 25% pyrethrin MUP (by weight), wherein the pyrethrin MUP is pyrethrin MUP 20.

12. The composition of claim 11, wherein the composition consists essentially of pyrethrin MUP and mineral oil.

13. A composition comprising pyrethrins and mineral oil.

14. The composition of claim 13, wherein the composition excludes any synergist.

15. The composition of claim 13, comprising about 50% to about 99% mineral oil (by weight).

16. The composition of claim 13, comprising about 0.1% to about 30% pyrethrins (by weight).

17. The composition of claim 13, comprising about 5% pyrethrins and about 95% mineral oil (by weight).

18. The composition of claim 17, wherein the composition consists essentially of pyrethrins and mineral oil.

19.-39. (canceled)

40. A composition comprising pyrethrum, mineral oil, and wintergreen oil.

41. A composition comprising pyrethrins, mineral oil, and wintergreen oil.

42. A composition comprising pyrethrins MUP, mineral oil, and wintergreen oil.

43. A composition comprising one or more pyrethrin, mineral oil, and wintergreen oil.

44. (canceled)

45. A composition comprising
(a) an extract from at least one flower selected from T. cinerariaefolium, C. cinerariaefolium, and C. coccineum, wherein the extract comprises pyrethrins;
(b) mineral oil; and
(c) wintergreen oil.

46.-49. (canceled)

50. A method for mosquito control comprising contacting a mosquito with an effective amount of the composition of claim 1.

51. (canceled)

52. The method of claim 50, wherein the composition is applied in an amount effective to kill about 95% of the contacted mosquito population.

53. A method for mosquito control comprising contacting a mosquito with an effective amount of the composition of claim 40.

54. The method of claim 53, wherein the composition is applied in an amount effective to kill about 95% of the contacted mosquito population.
